(19) United States
(12) Patent Application Publication
(10) Pub. No.: US 2017/0203607 A1
(43) Pub. Date: Jul. 20, 2017

(54) Wall Mounted, Portable, Stackable White Board Assembly

(71) Applicants: Philip J. Holmes, Novi, MI (US); Jonathan T. Moroney, Grand Haven, MI (US); Timothy S. Sporte, Grand Rapids, MI (US); Luciano Hernandez, IV, Holland, MI (US); Michael A. Johnson, West Olive, MI (US); Richard W. Harris, Grand Rapids, MI (US)

(72) Inventors: Philip J. Holmes, Novi, MI (US); Jonathan T. Moroney, Grand Haven, MI (US); Timothy S. Sporte, Grand Rapids, MI (US); Luciano Hernandez, IV, Holland, MI (US); Michael A. Johnson, West Olive, MI (US); Richard W. Harris, Grand Rapids, MI (US)

(21) Appl. No.: 15/406,931

(22) Filed: Jan. 16, 2017

Related U.S. Application Data
(60) Provisional application No. 62/279,711, filed on Jan. 16, 2016.

(51) Int. Cl. B43L 1/00; B43L 1/06

(52) U.S. Cl. CPC B43L 1/00; B43L 1/008; B43L 1/06

(57) ABSTRACT

A whiteboard assembly having a wall mount assembly and at least one panel assembly. The wall mount assembly being attachable to a wall and including a plurality of wall mount members. The panel assemblies each including a panel member and an attachment assembly. The panel member having a front and back surface and an outer perimeter. The attachment assembly having a plurality of attachment members coupled to the panel member. The panel member attachable through the attachment members to the wall mount assembly. A second panel member having substantially the same structural configuration is attachable to the first panel member through the respective attachment members. Methods of use are likewise disclosed.

### CROSS-REFERENCE TO RELATED APPLICATION

This application claims priority from U.S. Prov. Pat. App. Ser. No. 62/279,711 filed Jan. 16, 2016, entitled “Content Recognition And Presentation Export of Dynamic Whiteboard Modular System,” the entire specification of which is hereby incorporated by reference in its entirety.

### BACKGROUND OF THE DISCLOSURE

1. Field of the Disclosure

The disclosure relates in general to a presentation aid, and more particularly, to a wall mounted, portable, stackable whiteboard assembly. While not limited thereto, the whiteboard assembly can be mounted, releasably, by way of a wall mount assembly, to a wall or other outside structure and can be released and reattached to the same or other wall mount assemblies, or to other whiteboard assemblies in a nested configuration. It will also be described below that the assembly is not limited to a whiteboard, per se, and that whiteboard shall have a broader definition.

2. Background Art

The use of presentation aids and the like are well known in the art. Some of the earliest such presentation aids were the chalk board. With chalk boards, a user would write on the board (typically slate or, later, a synthetic material). This chalk marking could then be erased.

Through advances in technology, the chalkboard was steadily replaced by what is known as the whiteboard. The whiteboard is a material that can accept an erasable ink or marker that allows for dry erasing. Other display presentation aids include tackboards, pegboards, paperboard materials and other materials, as will be described below.

Problematically, many of such presentation aids are fixed to an outside surface, such as a wall. Thus, portability is difficult. Other presentation aids can be attached to wheeled stands or the like. While portable, these are rather large and cumbersome.

Other, more portable solutions are difficult to mount to a surface and use in various locations. Such portable solutions are rarely configured to be mounted properly yet temporarily on a wall or the like, and, when in use, are difficult to write upon.

### SUMMARY OF THE DISCLOSURE

The disclosure is directed to a whiteboard assembly comprising a wall mount assembly and at least one panel assembly. The wall mount assembly is configured for attachment to a wall structure, with the understanding that a wall structure can be a traditional fixed wall, or any mobile or fixed structure including, for example, but not limited to a cabinet, cart, frame structure and the like. The wall mount assembly has a plurality of wall mount members. Each wall mount member has an aligning structure and a coupling member. Each of the at least one panel assemblies has a panel member and an attachment assembly. The panel member has a front surface and a back surface, defining an outer perimeter. The attachment assembly includes a plurality of attachment member, each having a back portion and a front portion. The back portion is cooperatively engageable to the aligning structure of the wall mount members in mating engagement, and includes a back portion coupling member. The back portion coupling member is releasably attachable to the coupling member of one of the plurality of wall mount members. The front portion includes a panel aligning member and a panel coupling member. The panel aligning member functionally corresponds to the aligning structure of the wall mount members. The panel coupling member functionally corresponds to the coupling member of the wall mount members, so as to be configured to engage with a back portion of an attachment assembly of a second panel member.

In some configurations, the front panel comprises at least one of the group consisting of: a tackboard, corkboard, chalkboard, whiteboard, paperboard, glass board, ferromagnetic surfaces, a conventional whiteboard.

In some configurations, the aligning structure of the wall mount members further comprises at least one of a upstand and a cavity, and the back portion of the attachment members comprises the other of an upstand and a cavity, which are engageable in mating engagement.

In some configurations, the coupling member of each wall mount members comprises one of a magnet and a ferromagnetic material. Each of the coupling members of the back portion of the attachment members comprises the other of a magnet and a ferromagnetic material.

In some configurations, the coupling member of the front portion of the attachment members is the same as the coupling member of the wall mount members.

In some configurations, the panel aligning member of the front portion is structurally substantially identical to the aligning structure of the wall mount members.

In some configurations, the wall mount assembly includes four wall mount members, and the panel member includes four attachment members.

In some configurations, the panel member is substantially rectangular, defining four corners, with one of the four wall mount assemblies positioned in each of the four corners.

In some configurations, the attachment members are formed from a front half and a back half, which are attachable to each other and positioned so as to sandwich the panel member therebetween at a corner thereof.

In another aspect of the disclosure, a plurality of panel assemblies are provided. The front portions are configured to engage with a back portion of an attachment assembly of another one of the plurality of panel members, wherein the panel members are nestable together in overlying engagement.

In some configurations, the plurality of panel assemblies comprises four panel assemblies. Of course, less or more than four is likewise contemplated.

In some configurations, at least one of attachment members of the plurality of attachment members of each of the panel assemblies further includes a lift tab protruding outwardly therefrom so as to facilitate the decoupling of the panel assembly from other panel assemblies or from the wall mount members.

In some configurations, the aligning structure of the wall mount members and the front portion of the attachment members further comprises a substantially frustoconical upstand. The coupling member comprises one of a magnet and a ferromagnetic material positioned at the upper end of the frustoconical upstand.

In some configurations, the back portion of the attachment members further comprises a cavity having depending walls and a base wall. The depending wall and the base wall structurally configured for nesting engagement with the frustoconical upstand. The coupling member of the back portion of the attachment members comprising the other of a magnet and a ferromagnetic material.

In another aspect of the disclosure, the disclosure is directed to a method of using a whiteboard assembly comprising the steps of: securing a plurality of wall mount members to a wall, in a spaced apart orientation; providing a panel assembly having a panel member and a plurality of attachment members coupled to the panel member in an orientation that matches the spaced apart orientation of the wall mount members; matingly engaging the attachment members of the panel assembly with the wall mount members in releasable engagement.

In some configurations, the method further comprising the steps of: providing a second panel assembly having a panel member and a plurality of attachment members; matingly engaging the attachment members of the panel assembly with the attachment members of the second panel assembly so that the second panel assembly is releasably nested to the panel assembly and so that the second panel assembly overlies the first panel assembly.

In some configurations, the method further comprises the step of disengaging at least one of the panel assembly together with the second panel assembly from the wall mount members or the second panel assembly from the first panel assembly.

In some configurations, the method further comprises the steps of securing a second plurality of wall mount members to a wall spaced apart from the plurality of wall mount members; disengaging at least one of the panel assembly together with the second panel assembly from the wall mount members or the second panel assembly from the panel assembly; and matingly engaging the disengaged panel assembly or plurality of panel assemblies to the second plurality of wall mount members.

In some configurations, the method further comprises the steps of: providing at least a third panel assembly having a panel member and a plurality of attachment members; and matingly engaging the attachment members of the second panel assembly with the attachment members of the third panel assembly so that the third panel assembly is releasably nested to the second panel assembly and so that the third panel assembly overlies the second panel assembly.

In some configurations, the step of securing the plurality of wall mount members further comprises the use of at least one of fasteners and adhesive.

### BRIEF DESCRIPTION OF THE DRAWINGS

The disclosure will now be described with reference to the drawings wherein:

FIG. 1 of the drawings is a front perspective view of a whiteboard assembly of the present disclosure;

FIG. 2 of the drawings is a back perspective view of a whiteboard assembly of the present disclosure;

FIG. 3 of the drawings is side elevational view of a whiteboard assembly of the present disclosure;

FIG. 4 of the drawings is a front perspective view of a wall mount assembly of the whiteboard assembly of the present disclosure, showing, in particular, the wall mount onto an existing wall;

FIG. 5 of the drawings is a front perspective view of a wall mount member of the wall mount assembly of the whiteboard assembly of the present disclosure;

FIG. 6 of the drawings is a side elevational view of a wall mount member of the wall mount assembly of the whiteboard assembly of the present disclosure;

FIG. 7 of the drawings is a front perspective view of a panel assembly of the present disclosure;

FIG. 8 of the drawings is a front elevational view of the panel assembly of the present disclosure;

FIG. 9 of the drawings is back elevational view of the panel assembly of the present disclosure;

FIG. 10 of the drawings is a front perspective view of the attachment member of the panel assembly of the whiteboard assembly of the present disclosure;

FIG. 11 of the drawings is a back perspective view of the attachment member of the panel assembly of the whiteboard assembly of the present disclosure; and

FIG. 12 of the drawings is a front elevational view of three whiteboard assemblies in a side by side configuration, all mounted to an underlying wall.

### DETAILED DESCRIPTION OF THE DISCLOSURE

While this disclosure is susceptible of embodiment in many different forms, there is shown in the drawings and described herein in detail a specific embodiment(s) with the understanding that the present disclosure is to be considered as an exemplification and is not intended to be limited to the embodiment(s) illustrated.

It will be understood that like or analogous elements and/or components, referred to herein, may be identified throughout the drawings by like reference characters. In addition, it will be understood that the drawings are merely schematic representations of the invention, and some of the components may have been distorted from actual scale for purposes of pictorial clarity.

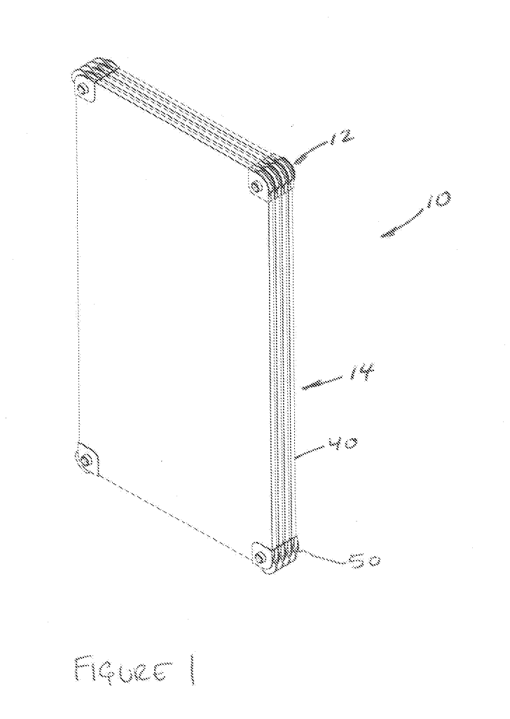

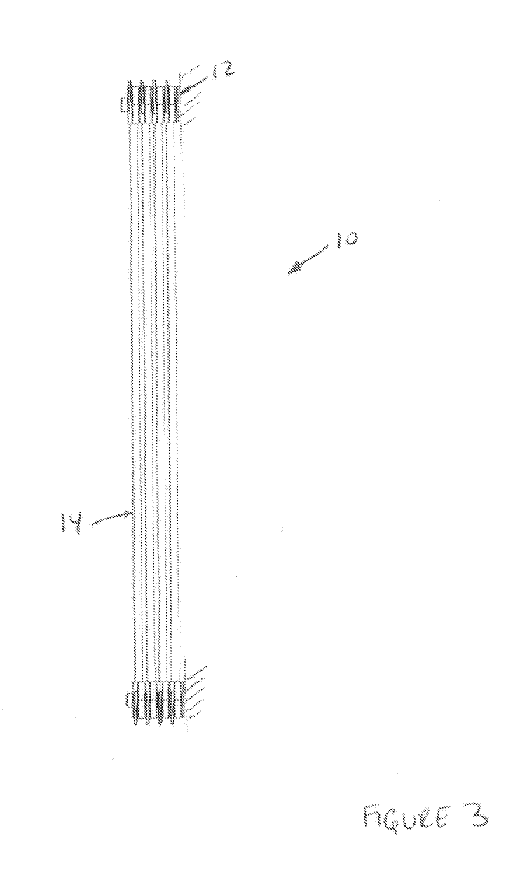

The wall mounted, portable, stackable whiteboard assembly is shown in FIGS. 1 through 3 generally at 10 (hereinafter often referred to as the assembly 10, or the whiteboard assembly 10). As will be described below, the whiteboard assembly is well suited for use in a variety of settings, and can be easily transported between walls, offices and locations. The whiteboard assembly is well suited, but not limited to use, for use in locations where space is a premium or where space is limited. It will further be understood that while the term “whiteboard” is utilized, the assembly is not limited for use with a traditional whiteboard material. Indeed, the term “whiteboard” will refer to any type of surface that the user would like to use, such as, for example, a tackboard, corkboard, chalkboard, whiteboard, paperboard, glass board, ferromagnetic surfaces, a conventional whiteboard or any other surface that the user would like to use, typically, but not exclusively for display or writing or demonstration. The particular material from which the panel is made or the type of use thereof is not limited, unless specifically claimed as such, and the term “whiteboard” shall encompass any one of such uses.

With reference to FIGS. 1 through 3, the whiteboard assembly comprises wall mount assembly 12 and a plurality of panel assemblies 14. In the configuration shown, four panel assemblies are stacked on top of each other with the wall mount assembly coupled to a wall surface. It will be understood that the whiteboard assembly is not limited to use with four panel assemblies, and that a single (as well as more or less than four panel assemblies) may be utilized. It will further be understood that, where there are multiple whiteboard assemblies, they may be different in structure and may have different front surfaces for different purposes. Alternatively, they may be the same.

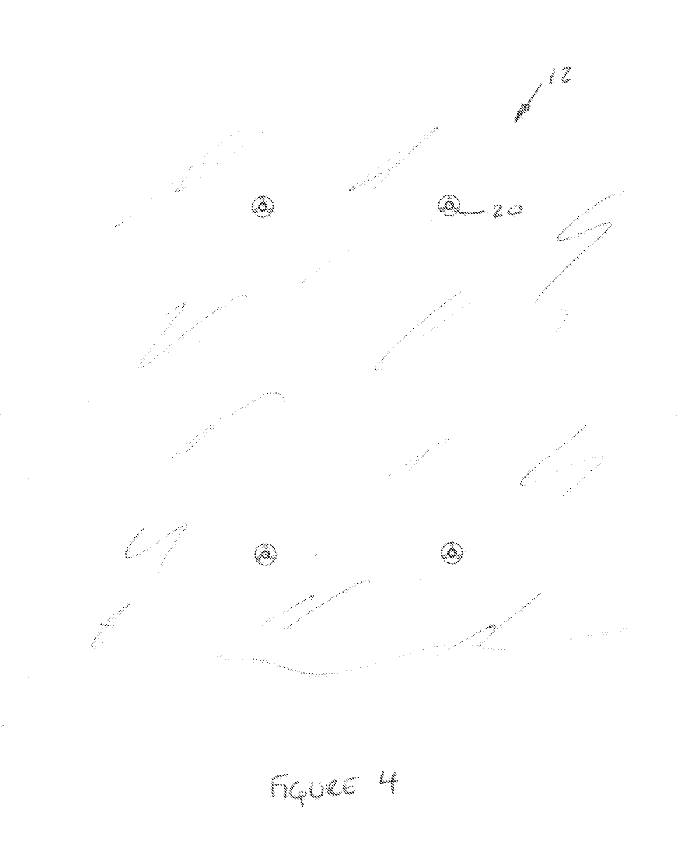

The wall mount assembly is shown in FIG. 4 as comprising a plurality of wall mount members 20. In the configuration shown, a total of four wall mount members are utilized (one at each corner of the whiteboard assembly). It will be understood that in other configurations, or even in this configuration, fewer than four wall mount members may be utilized, although, it will be understood that a greater number of wall mount members may also be utilized.

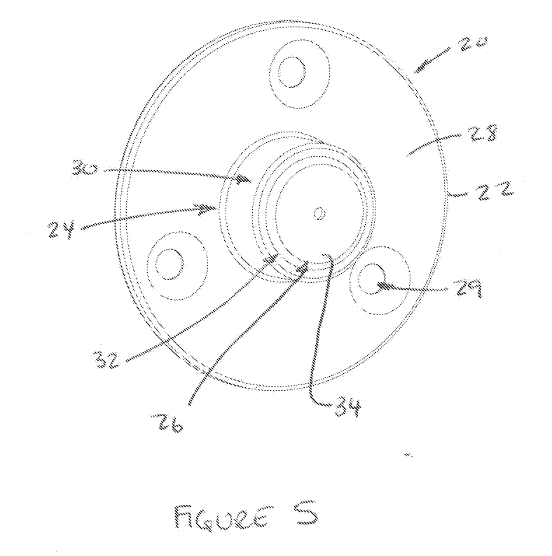

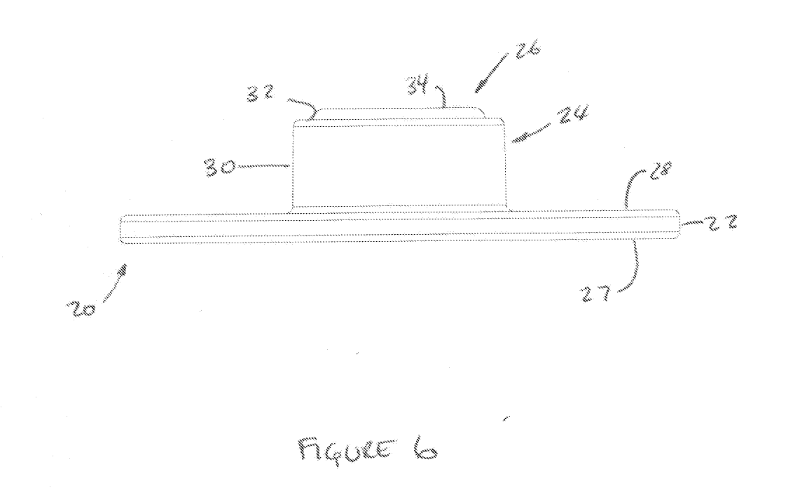

In the configuration shown, each of the wall mount members is substantially identical in configuration, with the understanding that in other configurations, the wall mount members may have multiple different constructions. An exemplary wall mount member 20 will be described with the understanding that the remaining wall mount members are substantially identical. With further reference to FIGS. 5 and 6, the wall mount member 20 includes base flange 22, aligning structure 24 and coupling member 26. The wall mount member aligning structure and base flange are integrally molded in the configuration shown. The base flange 22 is substantially planar and circular in configuration. The base flange 22 includes wall surface 27 and outer surface 28. A plurality of openings are disposed about the base flange wherein fasteners may be extended to couple the wall mount member to an outside surface, such as a wall. In other configurations, a glue, adhesive, tape, hook and loop fastener, or other attachment member can be utilized to couple the wall mount members to the underlying wall.

In the configuration shown, the aligning structure is centrally located relative to the base flange and includes upstand 30 and upper cavity 32. They upstand is substantially frusto-conical (and as will be explained, shape matingly engages the cavity of the attachment members 52 of the panel assembly 14). At the upper end of the aligning structure, an upper cavity 32 is defined.

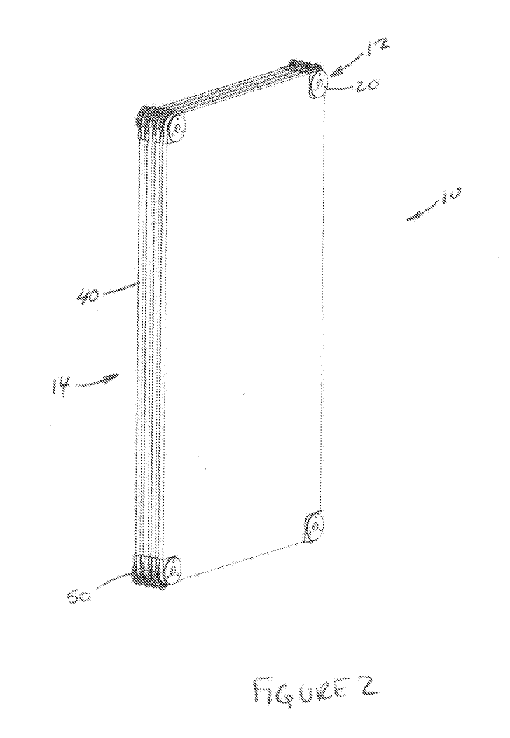

The coupling member 26 which enables releasable coupling with a corresponding attachment assembly is shown in FIG. 2 as comprising a magnet 34 that is positioned in the upper cavity 32 of the aligning structure 24. The magnet may comprise a rare earth magnet or the like. In other configurations, the coupling member may comprise a ferromagnetic material (such as iron or the like) which will engage with a magnet (where a magnet may be positioned in the cavity of the attachment members 52. In other configurations, the coupling member may comprise a hook and loop type of fastener that can engage with a corresponding hook and loop type fastener positioned within the cavity of the attachment members.

It will be understood that in the configuration shown, the aligning structure comprises a male coupling component that interfaces with the attachment members which are female coupling components. In other configurations, it will be understood that the aligning structure may comprise the female coupling component, while the attachment assembly may comprise the male coupling component. In such a case, the upstand would be present on the attachment assembly, and the cavity would be positioned on the attachment members for coupling thereto. Additionally, in such a configuration, the base flange of the wall mount member may be of increased thickness, for example, to accommodate the cavity that defines the aligning structure.

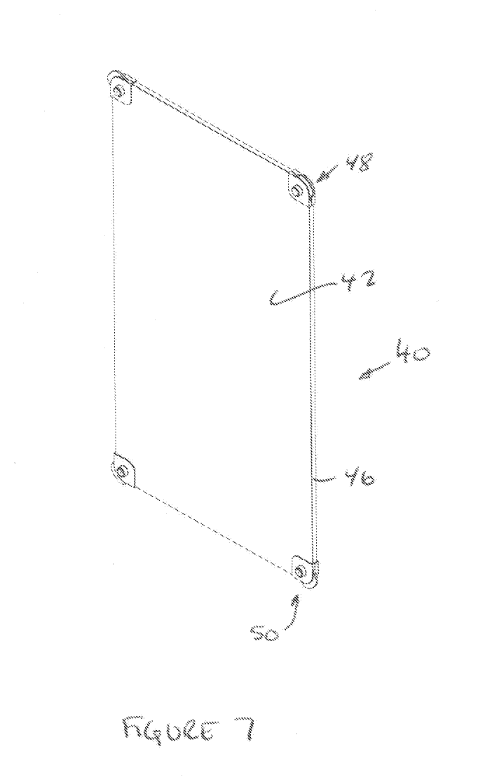

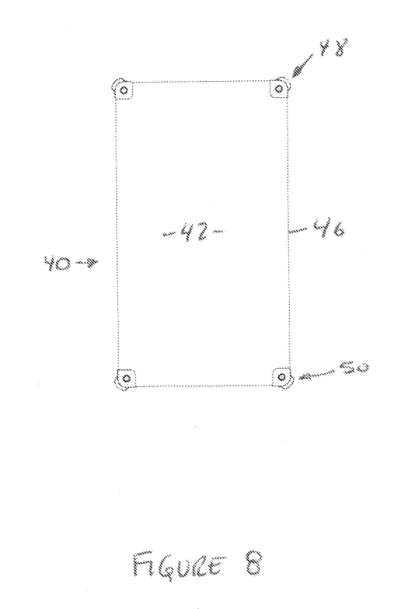

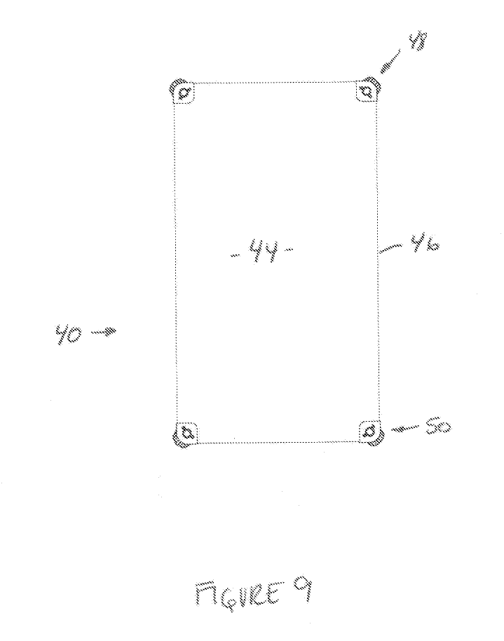

The panel assembly 14 is shown in FIG. 7 through 9 as comprising panel member 40 and attachment assembly 50. The panel member 40 generally comprises a substantially planar member that has a front surface 42 and a back surface 44 which cooperatively define an outer perimeter 46. In the configuration shown, the panel member comprises a whiteboard that has a planar surface and that is of a substantially rectangular configuration, having corner regions 48. Advantageously, the rectangular configuration substantially matches the aspect ratio of commonly used camera applications on smartphones, digital cameras and the like. It is contemplated, however that the panel member may comprise shapes other than rectangular, such as polygonal, square, triangular, circular, oval or arbitrary, among others.

As set forth above, the front surface comprises a whiteboard while other materials and surfaces are contemplated, such as a tackboard, corkboard, chalkboard, whiteboard, paperboard, glass board, ferromagnetic surfaces or any other surface that the user would like to use. Additionally, while a planar configuration is shown, a configuration having varying topography is likewise contemplated, as when stacked, the surfaces can be spaced apart from each other so as to permit the use of panels with topography. The panels can be of any size, for example, they may be 2′×4′ wherein four side by side panels generally define a 4′×8′ board. Other sizes are contemplated, both some that are larger and others that are smaller. The disclosure is not limited to any particular size or shape of the panel member.

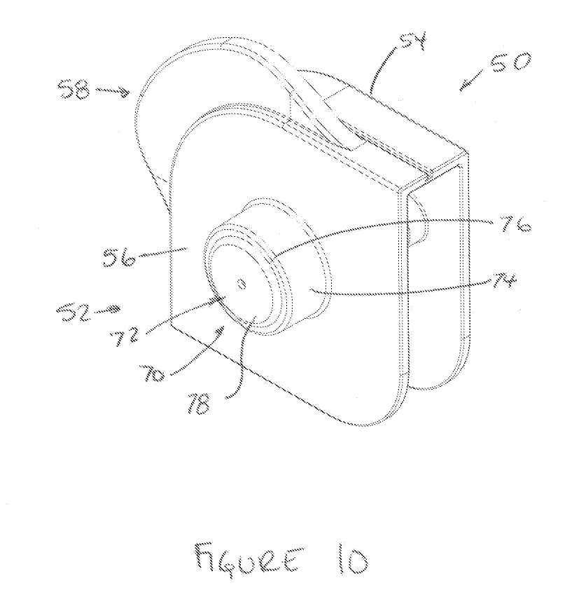

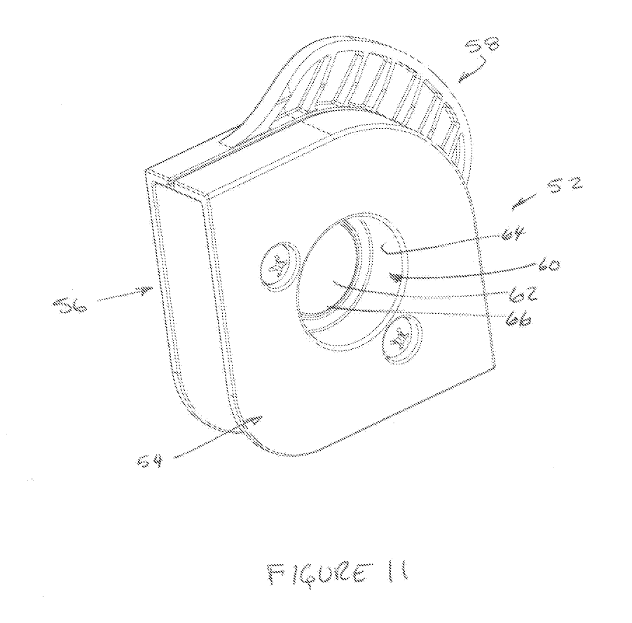

The attachment assembly 50 is shown in FIGS. 10 and 11 as comprising four attachment members, such as attachment member 52, that, in the configuration shown, are positioned in each of the corner regions 48. As shown in the figures, the attachment assembly 50 is formed by a front half and a back half that are positioned to overlie and sandwich a corner region 48 of the panel member, with fasteners that couple the structures together when positioned. Of course, other constructions are likewise contemplated. In some configurations, the panel member and the attachment member may be integrally molded or otherwise formed.

A single attachment member 52 will be described with the understanding that the remaining attachment members are substantially identical. The attachment member includes back portion 54, front portion 56 and lift tab 58. The back portion generally corresponds to the back half, the front portion generally corresponds to the front half and the lift tab is integrated with the front half. The back portion 54 includes cavity 60 and coupling member 62. In the configuration shown, the cavity 60 includes a depending wall 64 and a base wall 66. The cavity 60 corresponds in shape to the aligning structure so that the upstand 30 extends into, and shape matingly engages or aligns with the cavity 60. The coupling member 62 comprises a ferromagnetic material (or a magnet, or a hook and loop fastener, or another structure which fosters or maintains releasable engagement).

The front portion comprises a panel aligning member 70 and a panel coupling member 72. As will be understood, to allow for the nesting of the panel members, the panel aligning member and panel aligning member each have a similar configuration to, and a substantially identical function as, the aligning structure 24. That is, a panel member can be coupled to another panel member or to the wall mount members, as there is generally no functional difference between the two structures (although they may appear to be different, the operation is generally preferably although not required to be, substantially identical). As such, the front panel aligning member 70 includes panel upstand 74 and upper cavity 76. The panel coupling member 72 is positioned within the upper cavity 76 and comprises, preferably, a magnet (although it may comprise the above-described structures associated with the coupling member 26 of the wall mount members).

It will be understood that just as with the wall mount members, the attachment member may have the structures of the back portion and the front portion reversed. That is, the upstand may be disposed on the back member, and the mating or corresponding cavity may be disposed on the front member.

The lift tab 58 comprises a projection that extends outwardly from the corner region 48. The lift tab provides a means by which the user can grasp the corner region of a panel member and separate the panel member from adjacent panel members or from the wall mount member.

To assemble the assembly of the present disclosure, the user is first provided with the wall mount assembly 12. In particular, and, for example, with the configuration disclosed, a total of four wall mount members are provided (FIG. 4). The user measures or utilizes a template as to where these are to be mounted on a wall relative to each other to insure that they properly engage the panel member when in use. When the locations are determined, the user can attach each of the wall mount members to the wall. This can be done by extending fasteners through the openings on the base flange of the wall mount members and directing the fastener into the wall. In other configurations, this can be achieved by using the attachment structures and materials disclosed above.

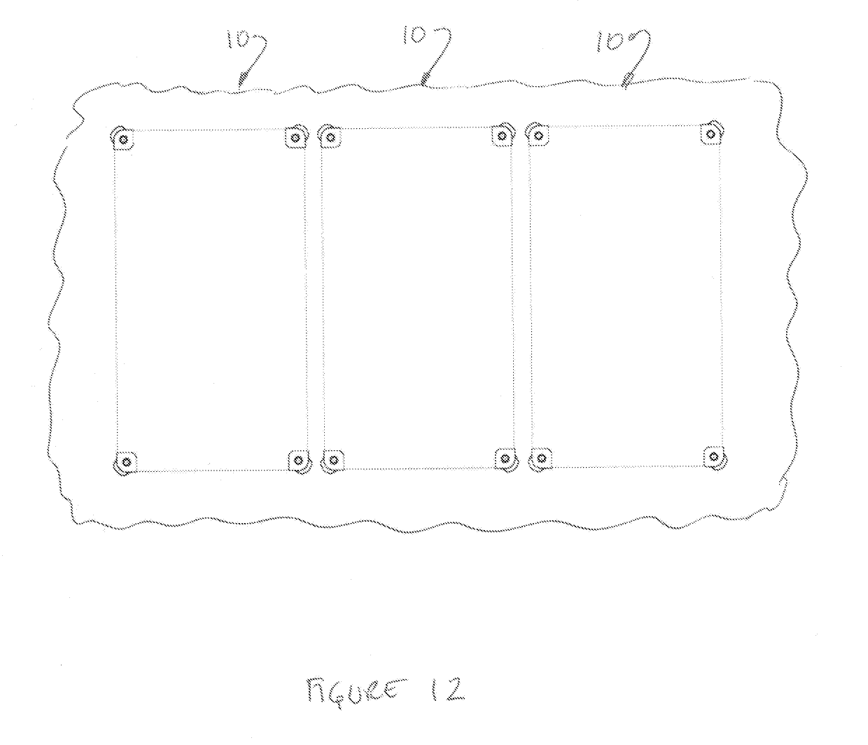

It will be understood that the user can assemble and position multiple wall mount members in appropriate groupings along a number of walls in the same room, in different rooms or in different locations. For example, and as shown in FIG. 12, two or more sets of wall mount assemblies may be mounted side by side to make a larger surface.

Once the wall mount members are installed, the user is provided with a panel assembly, and, in the configuration shown in FIGS. 1 through 3, the panel assembly includes multiple panel members, in this case four. The user can nest the panel members so that the front portion structures of the panel aligning member and the panel coupling member are coupled with the back portions of adjacent panel members. In the configuration shown, that would be the directing of the panel upstands into the corresponding cavities of adjacent panel members so that the structures were nested together. The magnets and ferromagnetic structures maintain the two configurations together in releasable, yet mating engagement. It will be understood that even where multiple panel members are nested together, the strength of the configuration precludes detachment or relative sliding of one panel member relative to another panel member.

Either a single panel member, or the panel assembly having multiple panel members can be coupled to a wall mount assembly. In particular, utilizing the same general concept as with the nesting, the lowermost panel member is directed over the wall mount members so that each can interface with a cavity of a back portion of the attachment members of the lowermost panel member. Once interfaced, the panel member, or the panel assembly, can be coupled to the wall. While in the figures, the panel members are shown to be generally vertically oriented, with their longest side being substantially vertical, it is likewise contemplated that any other mounting orientation is contemplated, that is horizontal or angular.

It will be understood that at any time, one or multiple ones of the panel members can be removed from coupling to each other or coupling to the wall mount assembly. This is achieved by grasping one or more of the lift tabs 58 and pulling or separating the structures.

In operation, a user can first utilize a panel member. For example, where the panel member is a whiteboard, the user can utilize the surface in a presentation or the like. If the user would like to show the presentation to someone in another room, the user can simply disconnect the panel member from another panel member (wherein the panel members are nested) or from the wall mount assembly (wherein the panel member is coupled to the wall mount assembly). Once disconnected, the user can go to the other room and place the panel member on a wall mount assembly in the room, or on other panel members which are coupled to a wall mount assembly in the room.

In another example, where a panel member has been filled or otherwise used by a user, and more space is desired, the user can simply place a second panel member over the first panel member (without moving the panel member) and couple the second panel member over the first panel member. It is further contemplated that a first panel member may be directly fastened to a wall, with other panel members being nestably coupled to this first panel member.

The foregoing description merely explains and illustrates the disclosure and the disclosure is not limited thereto except insofar as the appended claims are so limited, as those skilled in the art who have the disclosure before them will be able to make modifications without departing from the scope of the disclosure.

What is claimed is:

1. A whiteboard assembly comprising:
a wall mount assembly configured for attachment to a wall structure, the wall mount assembly having a plurality of wall mount members, each wall mount member having:
an aligning structure; and
a coupling member;
at least one panel assembly, the panel assembly including:
a panel member having a front surface and a back surface, defining an outer perimeter;
an attachment assembly including a plurality of attachment members, each having:
a back portion cooperatively engageable to the aligning structure of the wall mount members in mating engagement, and a back portion coupling member, the back portion coupling member releasably attachable to the coupling member of one of the plurality of wall mount members; and
a front portion including a panel aligning member and a panel coupling member, the panel aligning member functionally corresponding to the aligning structure of the wall mount members, and the panel coupling member functionally corresponding to the coupling member of the wall mount members, so as to be configured to engage with a back portion of an attachment assembly of a second panel member.

2. The whiteboard assembly of claim 1 wherein the front panel comprises at least one of the group consisting of: a tackboard, corkboard, chalkboard, whiteboard, paperboard, glass board, ferromagnetic surfaces, a conventional whiteboard.

3. The whiteboard assembly of claim 1 wherein the aligning structure of the wall mount members further comprises at least one of a upstand and a cavity, and the back portion of the attachment members comprises the other of an upstand and a cavity, which are engageable in mating engagement.

4. The whiteboard assembly of claim 3 wherein the coupling member of each wall mount members comprises one of a magnet and a ferromagnetic material, and each of the coupling members of the back portion of the attachment members comprises the other of a magnet and a ferromagnetic material.

5. The whiteboard assembly of claim 4 wherein the coupling member of the front portion of the attachment members is the same as the coupling member of the wall mount members.

6. The whiteboard assembly of claim 3 wherein the panel aligning member of the front portion is structurally substantially identical to the aligning structure of the wall mount members.

7. The whiteboard assembly of claim 1 wherein the wall mount assembly includes four wall mount members, and the panel member includes four attachment members.

8. The whiteboard assembly of claim 7 wherein the panel member is substantially rectangular, defining four corners, with one of the four wall mount assemblies positioned in each of the four corners.

9. The whiteboard assembly of claim 8 wherein the attachment members are formed from a front half and a back half, which are attachable to each other and positioned so as to sandwich the panel member therebetween at a corner thereof.

10. A whiteboard assembly comprising:
a wall mount assembly configured for attachment to a wall structure, the wall mount assembly having a plurality of wall mount members, each wall mount member having:
an aligning structure; and
a coupling member;
a plurality of panel assemblies, each panel assembly including:
a panel member having a front surface and a back surface, defining an outer perimeter;
an attachment assembly including a plurality of attachment members, each having:
a back portion cooperatively engageable to the aligning structure of the wall mount members in mating engagement, and a back portion coupling member, the back portion coupling member releasably attachable to the coupling member of one of the plurality of wall mount members; and
a front portion including a panel aligning member and a panel coupling member, the panel aligning member functionally corresponding to the aligning structure of the wall mount members, and the panel coupling member functionally corresponding to the coupling member of the wall mount members, so as to be configured to engage with a back portion of an attachment assembly of another one of the plurality of panel members, wherein the panel members are nestable together in overlying engagement.

11. The whiteboard assembly of claim 10 wherein the plurality of panel assemblies comprises four panel assemblies.

12. The whiteboard assembly of claim 10 wherein at least one of attachment members of the plurality of attachment members of each of the panel assemblies further includes a lift tab protruding outwardly therefrom so as to facilitate the decoupling of the panel assembly from other panel assemblies or from the wall mount members.

13. The whiteboard assembly of claim 10 wherein the aligning structure of the wall mount members and the front portion of the attachment members further comprises a substantially frustoconical upstand and the coupling member comprises one of a magnet and a ferromagnetic material positioned at the upper end of the frustoconical upstand.

14. The whiteboard assembly of claim 13 wherein the back portion of the attachment members further comprises a cavity having depending walls and a base wall, the depending wall and the base wall structurally configured for nesting engagement with the frustoconical upstand, with the coupling member of the back portion of the attachment members comprising the other of a magnet and a ferromagnetic material.

15. A method of using a whiteboard assembly comprising the steps of:
securing a plurality of wall mount members to a wall, in a spaced apart orientation;
providing a panel assembly having a panel member and a plurality of attachment members coupled to the panel member in an orientation that matches the spaced apart orientation of the wall mount members; and
matingly engaging the attachment members of the panel assembly with the wall mount members in releasable engagement.

16. The method of claim 15 further comprising the steps of:
providing a second panel assembly having a panel member and a plurality of attachment members; and
matingly engaging the attachment members of the panel assembly with the attachment members of the second panel assembly so that the second panel assembly is releasably nested to the panel assembly and so that the second panel assembly overlies the first panel assembly.

17. The method of claim 16 further comprising the step of:
disengaging at least one of the panel assembly together with the second panel assembly from the wall mount members or the second panel assembly from the first panel assembly.

18. The method of claim 16 further comprising the steps of:
securing a second plurality of wall mount members to a wall spaced apart from the plurality of wall mount members;
disengaging at least one of the panel assembly together with the second panel assembly from the wall mount members or the second panel assembly from the panel assembly; and
matingly engaging the disengaged panel assembly or plurality of panel assemblies to the second plurality of wall mount members.

19. The method of claim 16 further comprising the steps of:
providing at least a third panel assembly having a panel member and a plurality of attachment members; and
matingly engaging the attachment members of the second panel assembly with the attachment members of the third panel assembly so that the third panel assembly is releasably nested to the second panel assembly and so that the third panel assembly overlies the second panel assembly.

20. The method of claim 15 wherein the step of securing the plurality of wall mount members further comprises the use of at least one of fasteners and adhesive.
